(19) United States
(12) Patent Application Publication
(10) Pub. No.: US 2010/0176774 A1
(43) Pub. Date: Jul. 15, 2010

(54) METHOD FOR ADJUSTING SUPPLIED POWER IN COMPUTER SYSTEM BACKGROUND OF THE INVENTION

(75) Inventors: Jung-Tai Chen, Taipei (TW); Ko-Shu Chen, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTeK COMPUTER INC., Taipei (TW)

(21) Appl. No.: 12/639,273

(22) Filed: Dec. 16, 2009

(30) Foreign Application Priority Data
Jan. 9, 2009 (TW) 098100734

(51) Int. Cl. G05F 1/565

(52) U.S. Cl. 323/272

(57) ABSTRACT

A method for adjusting supplied power is used at a computer system and a multi-phase power supply. The multi-phase power supply includes a plurality of power converting units. The method includes the following steps. First, a load state of the computer system is detected. Second, the number of the actuated multi-phase power supply in the power converting units is adjusted according to the load state.

### FIELD OF THE INVENTION

The invention relates to a method for adjusting supplied power and, more particularly, to a method for adjusting supplied power used at a computer system and a multi-phase power supply.

### BACKGROUND OF THE INVENTION

The power needed by a computer system is usually supplied by a multi-phase power supply. The multi-phase power supply with preferred overall efficiency is realized mainly by combining a plurality of power converting units to solve the problem that a single power converting unit has low efficiency in a heavy load state. However, the system is not always in the heavy load state. For example, a graphics card of the computer system is not always in a three-dimensional (3D) image processing mode with high current consumption. On the contrary, it is always in a two-dimensional (2D) image processing mode with general power consumption. Therefore, when the multi-phase power supply having the power converting units operates in a low load state, the efficiency is not necessary to be optimum, and the efficiency may be bad.

### SUMMARY OF THE INVENTION

The invention provides a method for adjusting supplied power used at a computer system and a multi-phase power supply. The multi-phase power supply includes a plurality of power converting units therein. The method includes the following steps. First, a load state of the computer system is detected. Second, the number of the actuated power converting units in the multi-phase power supply is adjusted according to the load state.

According to the method for adjusting the supplied power according to the invention, detecting the load state of the computer system may be detecting an output current supplied to the computer system by the multi-phase power supply, and the number of the actuated power converting units in the multi-phase power supply is adjusted according to a change of the output current. When the value of the output current is detected to be bigger than or equal to a threshold value, the multi-phase power supply is operated in a first mode. When the value of the output current is detected to be smaller than the threshold value, the multi-phase power supply is operated in a second mode. The number of the actuated power converting units in the first mode is larger than the number of the actuated power converting units in the second mode.

According to the method for adjusting the supplied power according to the invention, the threshold value may correspond to a current value of an intersection point of two output current and corresponding efficiency curves in the first mode and the second mode.

Furthermore, According to the method for adjusting the supplied power according to the invention, detecting the load state of the computer system is detecting an image processing mode of a graphics card of the computer system, and the number of the actuated power converting units in the multi-phase power supply is adjusted according to a change of the image processing mode. When the image processing mode is detected to be a three-dimensional (3D) image processing mode, the multi-phase power supply is operated in a first mode. When the image processing mode is detected to be a two-dimensional (2D) image processing mode, the multi-phase power supply is operated in a second mode. The number of the actuated power converting units in the first mode is larger than the number of the actuated power converting units in the second mode.

According to the method for adjusting the supplied power according to the invention, detecting the load state of the computer system is detecting a power state of a central processing unit (CPU) of a computer system, and the number of the actuated power converting units in the multi-phase power supply is adjusted according to a change of the power state. When the power state is detected to be a first power state, the multi-phase power supply is operated in a first mode. When the power state is detected to be a second power state, the multi-phase power supply is operated in a second mode. The number of the actuated power converting units in the first mode is larger than the number of the actuated power converting units in the second mode.

### BRIEF DESCRIPTION OF THE DRAWINGS

These and other features, aspects and advantages of the present invention will become better understood with regard to the following description, appended claims, and accompanying drawings.

FIG. 1 is a function block diagram of a computer system using a method according to the invention;

FIG. 2 is a flow chart showing steps of a method for adjusting supplied power according to a first embodiment of the invention;

FIG. 3A is a curve diagram showing an output current and corresponding efficiency measured via a multi-phase power supply with two power converting units;

FIG. 3B is a curve diagram showing an output current and corresponding efficiency measured via a multi-phase power supply with three power converting units; and

FIG. 4 is a flow chart showing steps of a method for adjusting supplied power according to a second embodiment of the invention.

### DETAILED DESCRIPTION OF THE PREFERRED EMBODIMENT

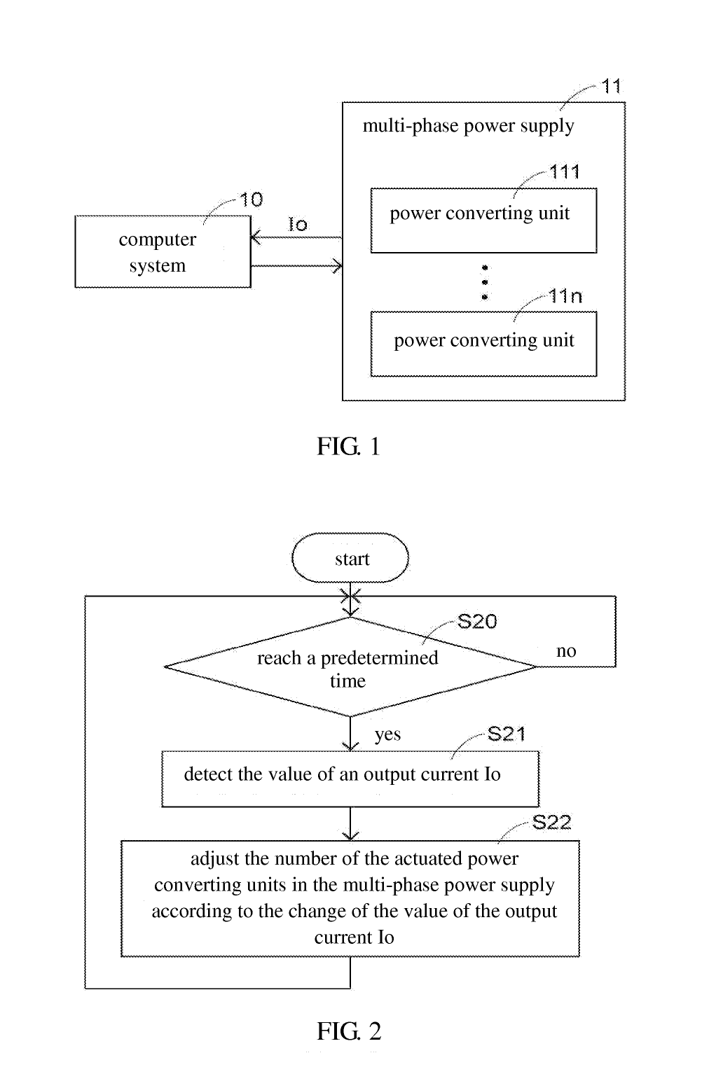

FIG. 1 is a function block diagram of a computer system using a method according to the invention. The function block diagram mainly includes a computer system 10 and a multi-phase power supply 11. The multi-phase power supply 11 supplies a proper output current to the computer system 10 according to an operating condition of the computer system 10. The multi-phase power supply 11 according to the invention includes a plurality of power converting units 111 to 11n which can be turned on or turned off independently. Therefore, the power converting units 111 to 11n are controlled by the computer system 10 to change the number of actuated power converting units. Thus, power conversion efficiency of the multi-phase power supply 11 may be changed.

FIG. 2 is a flow chart showing steps of a method for adjusting supplied power according to a first embodiment of the invention. First, the computer system 10 detects the value of an output current Io (step S21) supplied to the computer system 10 by the multi-phase power supply 11 every predetermined time (step S20). Then, the number of the actuated power converting units in the actuated power converting units 111 to 11n in the multi-phase power supply 11 is adjusted according to the change of the value of the output current Io (step S22), and the multi-phase power supply 11 is dynamically adjusted to obtain optimum power conversion efficiency.

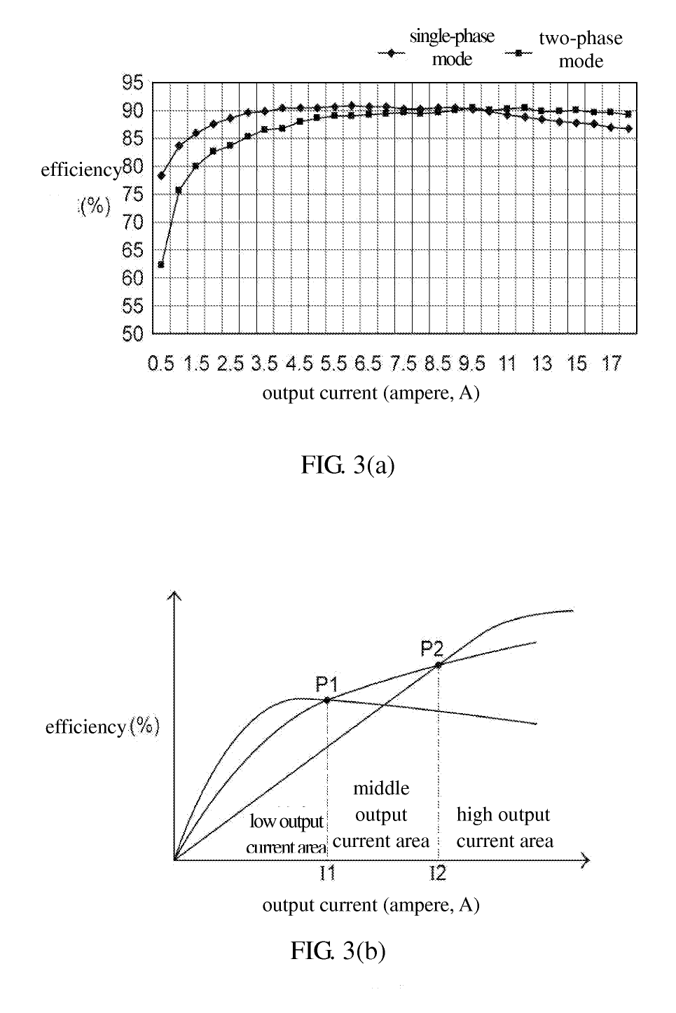

FIG. 3A is a curve diagram showing an output current and corresponding efficiency measured via a multi-phase power supply with two power converting units. Two curves represent the curves of the output current and the corresponding efficiency of a single actuated power converting unit (called a single-phase mode for short hereinafter) and two actuated power converting units (called a two-phase mode for short hereinafter), respectively. In FIG. 3A, the efficiency of the two-phase mode is higher than that of the single-phase mode in a heavy load and high output current area. However, the efficiency of the single-phase mode is higher in a light load and low output current area. In FIG. 3A, the two curves intersects at approximately ten amperes (A). Consequently, when the computer system 10 detects that the value of the output current is bigger than or equal to the threshold value of 10 amperes, it operates the multi-phase power supply in the two-phase mode. On the contrary, when the computer system 10 detects that the value of the output current is smaller than the threshold value of 10 amperes, it operates the multi-phase power supply in the single-phase mode. As a result, the power conversion efficiency can be optimized effectively, and thus the power can be saved.

FIG. 3B is a curve diagram showing an output current and corresponding efficiency measured via a multi-phase power supply with three power converting units. Three curves represent the output current and the corresponding efficiency curves of the single actuated power converting unit (called the single-phase mode for short hereinafter), the two actuated power converting units (called the two-phase mode for short hereinafter), and three actuated power converting units (called a three-phase mode for short hereinafter), respectively. In FIG. 3B, two intersection points P1 and P2 corresponding to a first current threshold value I1 and a second current threshold value I2 of the three curves divide the output current into three areas, a high output current area, a middle output current area, and a low output current area. Consequently, when the computer system 10 detects that the value of the output current is bigger than or equal to the second current threshold value I2, it operates the multi-phase power supply in the three-phase mode. When the computer system 10 detects that the value of the output current is smaller than the second current threshold value I2 and bigger than or equal to the first current threshold value I1, it operates the multi-phase power supply in the two-phase mode. When the computer system 10 detects that the value of the output current is smaller than the first current threshold value I1, it operates the multi-phase power supply in the single-phase mode. As a result, the power conversion efficiency of the multi-phase power supply with the three power converting units can be optimized effectively, and thus the power can be saved. Similarly, the power conversion efficiency with the multi-phase power supply with four or more power converting units can be effectively optimized by utilizing the method as stated above, which is not described herein for a concise purpose.

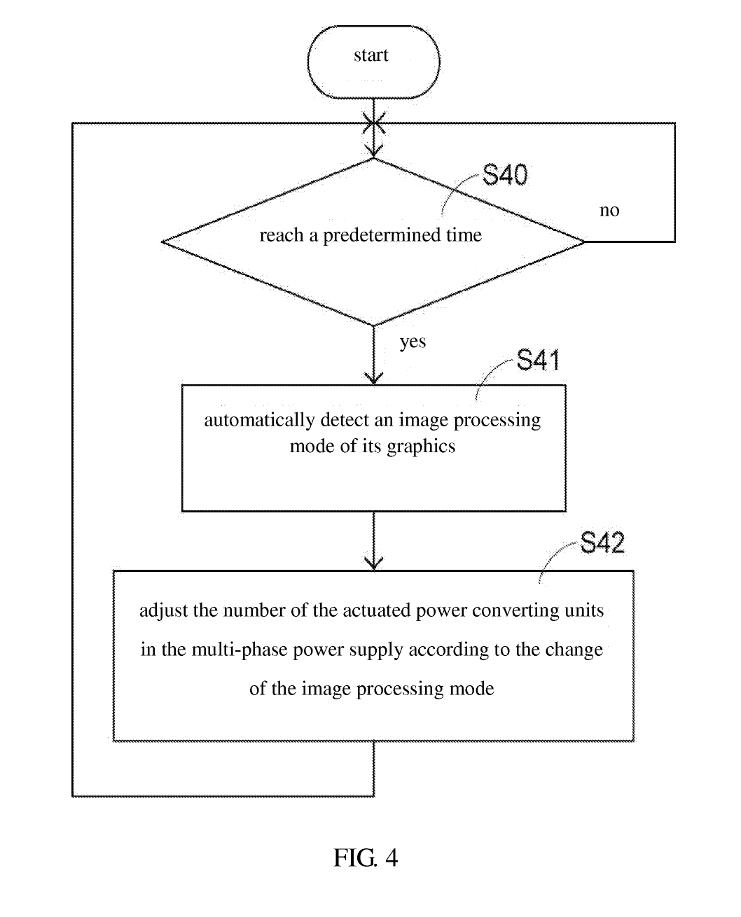

Additionally, the switching mode may be determined by detecting the output current Io supplied to the computer system 10 by the multi-phase power supply 11, the switching mode also may be determined by detecting different kinds of load states of the computer system 10 itself. FIG. 4 is a flow chart showing steps of a method for adjusting supplied power according to a second embodiment of the invention. First, the computer system 10 automatically detects an image processing mode of its graphics card (step S41) such as a 3D image processing mode with high current consumption and a 2D image processing mode with general power consumption every the predetermined time (step S40). Then, the number of the actuated power converting units in the actuated power converting units 111 to 11n in the multi-phase power supply 11 is adjusted according to the change of the image processing mode (step S42), and the multi-phase power supply 11 is dynamically adjusted to obtain the optimum power conversion efficiency. Besides the image processing mode, other modes also may relate to the load state. For example, a power state of a CPU may be taken as a reference for the value of power consumption to adjust the number of the actuated power converting units in the power converting units 111 to 11n in the multi-phase power supply 11. If the number of the power converting units is eight, and the CPU may have four power states, the multi-phase power supply 11 may be operated in four modes such as turning on two, four, six, and eight power converting units used for corresponding to four power states of the CPU, respectively. As a result, the efficiency of the power conversion approaches the optimum.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for adjusting supplied power, used at a computer system and a multi-phase power supply, wherein the multi-phase power supply includes a plurality of power converting units, the method comprising:
detecting a load state of the computer system; and
adjusting the number of the actuated power converting units in the multi-phase power supply according to the load state.

2. The method for adjusting the supplied power according to claim 1, wherein detecting the load state of the computer system is detecting an output current supplied to the computer system by the multi-phase power supply, and the number of the actuated power converting units in the multi-phase power supply is adjusted according to a change of the output current.

3. The method for adjusting the supplied power according to claim 2, wherein when the value of the output current is detected to be bigger than or equal to a threshold value, the multi-phase power supply is operated in a first mode, when the value of the output current is detected to be smaller than the threshold value, the multi-phase power supply is operated in a second mode, and the number of the actuated power converting units in the first mode is larger than the number of the actuated power converting units in the second mode.

4. The method for adjusting the supplied power according to claim 3, wherein the threshold value corresponds to a current value of an intersection point of two output current and corresponding efficiency curves in the first mode and the second mode.

5. The method for adjusting the supplied power according to claim 1, wherein detecting the load state of the computer system is detecting an image processing mode of a graphics card of the computer system, and the number of the actuated power converting units in the multi-phase power supply is adjusted according to a change of the image processing mode.

6. The method for adjusting the supplied power according to claim 5, wherein when the image processing mode is detected to be a three-dimensional (3D) image processing mode, the multi-phase power supply is operated in a first mode, when the image processing mode is detected to be a two-dimensional (2D) image processing mode, the multi-phase power supply is operated in a second mode, and the number of the actuated power converting units in the first mode is larger than the number of the actuated power converting units in the second mode.

7. The method for adjusting the supplied power according to claim 1, wherein detecting the load state of the computer system is detecting a power state of a central processing unit (CPU) of the computer system, and the number of the actuated power converting units in the multi-phase power supply is adjusted according to a change of the power state.

8. The method for adjusting the supplied power according to claim 7, wherein when the power state is detected to be a first power state, the multi-phase power supply is operated in a first mode, when the power state is detected to be a second power state, the multi-phase power supply is operated in a second mode, and the number of the actuated power converting units in the first mode is larger than the number of the actuated power converting units in the second mode.
